(19) United States
(12) Patent Application Publication
(10) Pub. No.: US 2009/0121954 A1
(43) Pub. Date: May 14, 2009

(54) Device for Emitting and Receiving Electromagnetic Radiation

(76) Inventor: Thomas Binzer, Stuttgart (DE)

Correspondence Address: KENYON & KENYON LLP, ONE BROADWAY, NEW YORK, NY, 10004, US

(21) Appl. No.: 11/795,785

(22) PCT Filed: Jan. 9, 2006
(86) PCT No.: PCT/EP2006/050095

§ 371 Date: May 12, 2008

(30) Foreign Application Priority Data
Jan. 19, 2005 (DE) 102005002505.6

(51) Int. Cl. H01Q 13/00; H01Q 1/36

(52) U.S. Cl. 343/785; 343/841; 343/898; 343/700 MS

(57) ABSTRACT

A device for emitting and receiving electromagnetic radiation, in particular microwave radiation, including at least one feed element, at least one hollow conductor and at least one rod radiator, the feed element being situated on a first end of the hollow conductor in such a way that the power emitted by the feed element is passed through the hollow conductor and/or the received power that is passed through the hollow conductor is injected into the feed element and the rod radiator is situated at a second end of the hollow conductor in such a way that the transmit power passed through the hollow conductor is bundled and emitted via the rod radiator and/or the incoming received power is bundled by the rod radiator and conducted into the hollow conductor.

### FIELD OF THE INVENTION

The present invention relates to a device for emitting and receiving electromagnetic radiation, in particular microwave radiation, having at least one feed element, at least one hollow conductor, and at least one rod radiator, the feed element being situated at a first end of the hollow conductor in such a way that the power emitted by the feed element is conducted through the hollow conductor and/or the received power conducted through the hollow conductor is input into the feed element, and the rod radiator is situated at a second end of the hollow conductor in such a way that the transmit power conducted through the hollow conductor is bundled via the rod radiator and emitted and/or the incoming received power is bundled by the rod radiator and directed into the hollow conductor.

### BACKGROUND INFORMATION

German Patent Application No. DE 199 39 834 describes a multibeam radar sensor having a mount for a focusing body in which focusing bodies are situated between a lens and the transmission/reception elements in such a way that they prefocus the radiation of a transmission/reception element with respect to the electric lens. The focusing bodies are secured by a dielectric plate into which a mount is inserted. The mount is designed with respect to its material and its geometric dimensions so that the least possible coupling occurs between the individual focusing bodies. With this device there is the problem that there is unwanted emission of electromagnetic radiation by the transmission and reception elements, which is not detected via the prefocusing bodies. Accordingly, it is also possible for the transmission and reception elements as well as the additional components mounted around these transmission and reception elements not to be shielded from the outside with respect to interfering electromagnetic radiation.

### SUMMARY OF THE INVENTION

A core of the present invention is to provide a device for emitting and receiving electromagnetic radiation, in which the circuit carrier on which the transmission and reception elements, hereinafter referred to as feed elements, may be electromagnetically shielded in the transmission and reception directions without reflections of electromagnetic radiation, which may be emitted to the prefocusing body by the transmission and reception elements being able to produce reflections on the shielding device, and decoupling between the individual transmission/reception elements is prevented. According to the present invention, this object is achieved by providing hollow conductor segments between the feed elements and the prefocusing bodies.

The at least one feed element is advantageously situated on a circuit carrier. This makes it possible to attach the transmission and reception means via the circuit carrier and protect them from unwanted disadjustment as a result of mechanical stress.

It is also advantageous that the feed element is a patch antenna or a microstrip line. Due to the design of the at least one feed element in the form of a patch antenna or in the form of a no-load microstrip line, it is possible to implement it inexpensively by an etching process on the circuit carrier while nevertheless being able to input most of the transmit power into the hollow conductor.

It is also advantageous that the hollow conductor is mounted on the circuit carrier. Due to the mounting of the hollow conductor on the circuit carrier via an inexpensive soldering operation, it is possible to achieve a sturdy and permanent connection of the hollow conductor to the circuit carrier and to minimize crosstalk between the individual transmission and reception channels.

In particular, it is also advantageous that the hollow conductor is electrically connected to the ground of the circuit carrier. This makes it possible to avoid floating potentials of the hollow conductors. It is also inexpensively possible to easily contact the solder surfaces by which the hollow conductors are mounted on the circuit carrier via through-contacts in the circuit carrier to achieve a ground contact that is easy to implement and to securely join the hollow conductor to the circuit carrier.

It is also advantageous that the hollow conductor is a round hollow conductor because in this way the prefocusing bodies may also be implemented in a rotationally symmetrical form to thereby be able to join them ideally to the hollow conductor. The joining of the rod radiator to the hollow conductor may be accomplished here via an adhesive method, for example, in such a way that the prefocusing body completely seals the end of the hollow conductor.

Multiple transmission and reception assemblies each including a feed element, a hollow conductor and a rod radiator are advantageously situated side by side, so that multibeam transmission and reception equipment is implementable, and the angle of incidence of the received electromagnetic radiation may thus be determined by phase analysis of the various transmission and reception channels, for example.

It is particularly advantageous that the circuit carrier in the transmission and reception equipment of the assembly is electrically shielded by a metal plate. This offers the advantage that unfocused transmit power does not emit any interfering radiation and is unable to generate interfering reflections because it is shielded toward the outside by the metal plate and the incident interfering electromagnetic radiation is unable to strike the transmission and reception elements.

It is also advantageous that in the area of the hollow conductor(s), the metal plate has recesses through which the hollow conductor(s) may be passed so that the transmit power to be emitted and/or the received power to be received may be passed through the metal plate via the hollow conductors without resulting in any diffraction or reflection on the metal plate.

It is also advantageous that a dielectric lens is provided to focus the emitted and/or received radiation so that the beam paths of the prefocused individual beams are able to be focused according to the particular application. In particular when using this device in a motor vehicle for adaptive distance and cruise control, it is advantageous to design the dimensions of the dielectric lens so that the emitted and received radiation detects the area of the road surface in front of one's own vehicle but intentionally does not detect irrelevant objects outside of this detection range.

### BRIEF DESCRIPTION OF THE DRAWINGS

FIG. 1 shows a schematic sectional diagram of the device of a single transmission and reception element according to the present invention.

FIG. 2 shows a three-dimensional view of an assembly of multiple transmission and reception elements.

### DETAILED DESCRIPTION

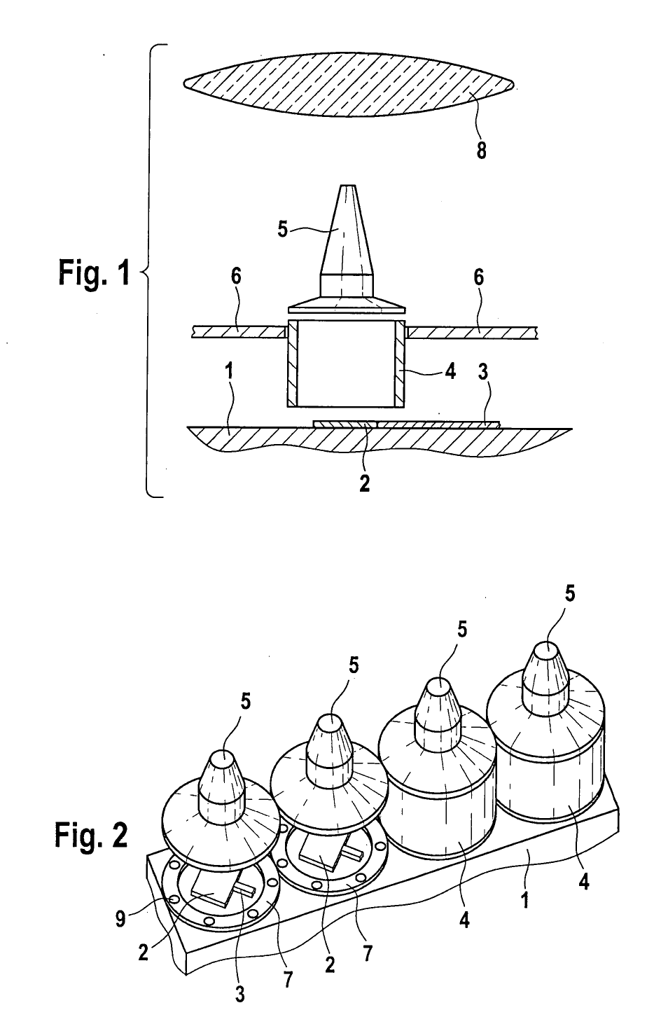

FIG. 1 shows a schematic sectional diagram of the assembly according to the present invention in which the individual parts are shown separately, i.e., not joined together, in order to facilitate understanding. The individual parts are of course at least partially joined together to obtain a stable and sturdy device. This shows a circuit carrier 1, which may be implemented as a high frequency circuit carrier, for example. This circuit carrier includes electric components manufactured in a planar style, for example. In addition, feed elements 2 are provided on circuit carrier 1 which, situated on circuit carrier 1, may also be manufactured using planar technology and may be in the form of patch antennas, for example. Patch antennas 2 are joined via a microstrip line 3, for example, to conduct transmit power to patch antennas 2 and/or to conduct received power from patch antennas 2 to downstream components. According to the present invention, instead of a patch antenna, the feed element may also be designed as a no-load microstrip line, which also emits in the direction of the hollow conductor and receives reception signals from this direction.

A hollow conductor 4 is situated above feed element 2, its direction of wave propagation being approximately normal to the surface of circuit carrier 1. This hollow conductor 4 may advantageously be connected to circuit carrier 1 by, for example, structuring contact faces on circuit carrier 1 to which hollow conductor 4 may be soldered. The transmit power to be emitted is emitted by feed element 2 in the direction of propagation of the hollow conductor and is conducted by the hollow conductor to its other end. A rod radiator 5, which prefocuses the transmit power passed through the hollow conductor and emits it in the transmission/reception direction is advantageously attached on the second end of the hollow conductor which is situated on the side of the hollow conductor facing away from feed element 2. The rod radiator is therefore advantageously made of a dielectric material.

According to another design variant, a metal plate 6 may be provided to shield circuit carrier 1 from the electromagnetic radiation in the transmission and reception directions and/or preventing interfering radiation emitted by circuit carrier 1 from propagating into the environment. To prevent diffraction and reflection of the transmission and reception radiation on metal plate 6, it is advantageous to provide at least one recess in metal plate 6 through which hollow conductor 4, which may be designed as a round hollow conductor, for example, may protrude exactly. This prevents reflection and diffraction on metal plate 6 and shields circuit carrier 1 from its own interfering radiation as well as external interfering radiation. According to another design variant, it is additionally possible to provide a dielectric lens 8 which bundles the radiation prefocused by the rod radiator according to the transmission and reception range of the device.

FIG. 2 shows a three-dimensional view of a multibeam transmission and reception device embodying the idea according to the present invention. This again shows circuit carrier 1 on which feed elements 2 are situated, each being contacted electrically via microstrip lines 3, for example. In the example illustrated here, feed elements 2 are designed as patch antennas, but it is also possible to lengthen microstrip lines 3 instead of having patch antennas 2, so that microstrip lines 3 function as feed elements. According to another embodiment, it is possible to provide a contact area 7 for hollow conductor 4 around feed elements 2, this contact area connecting the hollow conductor to the electric mesh of circuit assembly 1 via through-contacts 9, for example. To facilitate understanding, FIG. 2 shows a total of four transmission and reception channels, each shown above an assembly including a feed element, a hollow conductor and a rod radiator. For the sake of illustration, hollow conductors 4 on the two left assemblies are not shown here, so that the feed elements concealed behind them with their contacts and contacts 7 of the hollow conductors are visible. Corresponding rod radiators 5 are shown as floating with regard to the two left channels. The two right transmission and reception channels are shown with hollow conductors 4 which conceal feed elements 2 and contacts 7 of the hollow conductors. Hollow conductors 4 are particularly advantageously designed as round hollow conductors and are soldered to ground ring 7 of the circuit carrier. The prefocusing bodies in the form of rod radiators are mounted on the upper end of the round hollow conductors, e.g., by an adhesive operation.

For reasons of simplicity, metal plate 6 is not shown in FIG. 2, but in the area of the round hollow conductors, it has recesses through which round hollow conductors 4 may be passed so that complete shielding of circuit carrier 1 is achieved. Likewise, FIG. 2 does not show dielectric lens 8, which focuses the four individual channels accordingly. The transmission signals carried via microstrip lines 3 are emitted to patch antennas 2 which emit the transmit power in the direction of the axis of symmetry of round hollow conductors 4. The transmit power emitted by feed elements 2 is carried through round hollow conductor 4 and bundled and emitted at the upper end of round hollow conductor 4 via the rod radiators which function as prefocusing bodies, before the individual channels are focused via dielectric lens 8, not shown in FIG. 2. In the reception case, the incident reception radiation is focused via dielectric lens 8 (not shown) approximately on prefocusing bodies 5 designed as rod radiators and injected into round hollow conductors 4 by the rod radiators. The received power is passed through round hollow conductors 4 through the recesses in metal plate 6 (not shown) and injected at the lower end of round hollow conductors 4 into feed element 2, which may be designed as a patch antenna or as a no-load microstrip line, for example, and relayed for further processing to downstream electric components.

1-10. (canceled)

11. A device for emitting and receiving electromagnetic radiation, comprising:
at least one feed element;
at least one hollow conductor; and
at least one rod radiator,
wherein the feed element is situated on a first end of the hollow conductor in such a way that at least one of (a) a transmit power emitted by the feed element is passed through the hollow conductor and (b) a received power that is passed through the hollow conductor is coupled into the feed element, and wherein the rod radiator is situated at a second end of the hollow conductor in such a way that at least one of (c) a transmit power passed through the hollow conductor is bundled and emitted via the rod radiator and (d) an incoming received power is bundled by the rod radiator and conducted into the hollow conductor.

12. The device according to claim 11, wherein the radiation includes microwave radiation.

13. The device according to claim 11, further comprising a circuit carrier, the feed element being situated on the circuit carrier.

14. The device according to claim 11, wherein the feed element includes one of a patch antenna and a microstrip line.

15. The device according to claim 13, wherein the hollow conductor is mounted on the circuit carrier.

16. The device according to claim 13, wherein the hollow conductor is electrically connected to the ground of the circuit carrier.

17. The device according to claim 11, wherein the hollow conductor is a round hollow conductor.

18. The device according to claim 11, wherein multiple transmission and reception assemblies are situated side by side.

19. The device according to claim 13, further comprising a metal plate for electrically shielding the circuit carrier in a transmission and reception direction of an assembly.

20. The device according to claim 19, wherein in an area of the hollow conductor the metal plate has recesses through which the hollow conductor is passed.

21. The device according to claim 11, further comprising a dielectric lens for focusing at least one of emitted radiation and received radiation.
